(19) United States
(12) Patent Application Publication
(10) Pub. No.: US 2016/0183733 A1
(43) Pub. Date: Jun. 30, 2016

(54) CUTTING BOARD WITH COLLAPSIBLE HOOD

(71) Applicant: Robinson Home Products Inc, Williamsville, NY (US)

(72) Inventors: Stuart Harvey Lee, Forest Hills, NY (US); Jochen Schaepers, New York, NY (US)

(21) Appl. No.: 14/582,293

(22) Filed: Dec. 24, 2014

(51) Int. Cl. A47J 47/00

(52) U.S. Cl. CPC A47J 47/005

(57) ABSTRACT

A cutting board comprising a cutting surface, said cutting surface having a front edge, a back edge, a first side edge and a second side edge, and a collapsible hood member convertible from a collapsed to an expanded configuration, the hood member extending along at least a portion of at least one edge of the cutting surface. The collapsible hood member provides a retention wall for catching and holding cuttings or liquids from dropping onto a work area when in the expanded configuration and preferably creates a groove about at least a portion of the cutting surface when in the collapsed configuration. The cutting board preferably has an angled cutting surface that biases the cutting surface toward the hood member to direct the liquids and cuttings away from the work area of the cutting surface.

### FIELD OF THE INVENTION

The present invention relates to kitchen accessories, and more particularly to a cutting board with a collapsible hood which can be configured from an expanded configuration to a collapsed configuration.

### BACKGROUND OF THE INVENTION

Cutting boards are well known to be common food preparation items in virtually all kitchens. They vary in style and size, ranging from small, square, or circular planks of wood to independently freestanding tables, and have been constructed from a variety of materials including wood, glass, plastic, and stone. Cutting boards are essential for protecting surfaces from being scratched by a knife blade and are also commonly used to transport the cut product or scraps (hereinafter “cuttings”) to different locations within the kitchen, such as a cooking utensil, the sink or garbage.

While cutting boards come in various styles and have been adapted to present users with a multitude of new conveniences and advantages, it remains that the existing designs of cutting boards have several drawbacks which limit their effectiveness and utility. For example, cuttings are often moved away from the cutting or work area, toward the back or a side of the cutting board, whether it is for later use, disposal or merely to keep the work area clear. However, the cuttings may spill from the cutting board onto the countertop and/or floor when the user moves the cuttings away from the work area, attempts to scoop up the cuttings or carry the cutting board with the cuttings to another location.

Additionally, it is often challenging to move the cuttings from the cutting board, especially when the cuttings are to be deposited into a container such as a cooking utensil, including a pot or pan, a plate, a bowl, a colander or other receptacle. The large flat surface of the common cutting board does not lend itself to the precise movement of the cuttings off of the cutting board and into such a utensil or container without some cuttings falling outside of the utensil or container.

In light of these limitations, cutting boards have been designed where the cutting surface can be folded and/or funneled to better transport and direct the cuttings into a container. An example of such folding cutting boards can be found in U.S. Pat. No. 5,501,441, which is directed to a cutting board that is normally spring biased into a flat position for cutting, then able to be folded along the center line to form a chute for easy direction of cuttings into a container.

Another example of such a cutting board can be found in U.S. Pat. No. 5,203,548, which describes a chopping board that is foldable along a grooved line extending through the chopping area and along the length of the board. This device includes a handle member extending from the chopping board for easy handling of the cutting board and transport of the board and cuttings to a desired area.

These cutting boards, like traditional cutting boards, generally lay flat on a surface with an even height throughout, making it difficult to control the flow of liquids, such as fluids or juices that are generated from the food item being processed on the cutting board. Efforts to control liquids from food items being processed on a cutting board have generally been in the form of providing a groove, channel or trough around the perimeter of the cutting surface which prevents liquids from spilling off of the cutting board. However, such grooves reduce the amount of work space on a cutting board, since the grooved area interferes with the use of a knife and is generally not suited to cutting food items

As such, and notwithstanding the above, there is a need for a cutting board which allows the user to conveniently cut, catch, transport and dispose of both wanted and unwanted cuttings and/or liquids.

### SUMMARY OF THE INVENTION

The cutting board of the present invention is provided in order to overcome the shortcomings of the existing products. In keeping, it is an object of the present invention to provide an improved cutting board that can catch, hold and direct cuttings and liquids from the work surface. It is a further object to provide such a cutting board that can be transformed from a configuration which maximizes access to the work area to a configuration that can stop and retain cuttings moved away from the work area. It is also an object of the invention to provide an improved cutting board to be collapsed to minimize the size for storage.

These and other objects are addressed by the present invention, directed to a cutting board comprising a cutting surface, said cutting surface having a front edge, a back edge, a first side edge and a second side edge, and a collapsible hood member convertible from a collapsed configuration to an expanded configuration, said hood member extending along at least a portion of at least one edge of the cutting surface. Preferably, the cutting surface is angled or biased toward the collapsible hood, such that cuttings and liquids and/or cuttings from the food item being processed are directed toward the hood member.

The collapsible hood member comprises one or more folding sections in a flexible wall coupled to the cutting surface. The flexible wall may, but does not necessarily, include a substantially rigid rim about the terminal end to maintain the shape of the hood and to aid in transforming the hood member between the expanded and collapsed configurations. In any event, the terminal portion of the hood member preferably has an outwardly extending portion for more easily transforming the hood member between its collapsed and expanded configurations.

The hood member preferably extends continuously along at least a portion of two adjacent edges of the cutting surface in order to collect the cuttings and/or liquids and prevent them from falling or spilling off of the cutting board, as well as to provide a chute or spout for quick and clean displacement of the cuttings into containers with smaller openings.

The flexible wall of the collapsible hood member preferably folds along living hinges into a collapsed configuration wherein the folds of the collapsed body of the hooded member create a groove that extends along the edge or edges of cutting surface. This groove may be used to catch liquids from flowing off of the cutting board before running off of the cutting surface and onto the countertop or table surface on which the cutting board is being used. The groove catches and holds the liquids during food preparation, and also allows for easy transport of the liquid to a container, when the liquids are juices being used, i.e., for making gravy, or to a sink or garbage for disposal.

In a preferred embodiment, the collapsible hood member extends along the entire back edge and at least a portion of each of the side edges of the cutting surface. The most preferred embodiment of the collapsible hood member extends along the entire back edge and a majority of each of the side edges of the cutting surface, so as to maximize the utility of the collapsible hood as well as to minimize interference with the user during food processing on the cutting surface.

The preferred cutting board has a cutting surface that is angled or biased toward the collapsible hood member to permit liquids to flow toward the hood member, where they can be retained away from of the work area. The cutting board can be biased by including one or more feet, including legs, stands or other protrusions, on the underside of the cutting board or by providing the cutting board with converging top and bottom surfaces that are thinner at the edge on which the hooded member is associated.

In this regard, the use of one or more feet on at least one edge opposite the edge on which the hooded member resides is preferred, with feet on each of the four corners of the cutting board being most preferred. In this embodiment, the feet at the area associated with the front edge of the cutting surface are preferably taller than the feet associated with the back edge, wherein the height difference of the feet creates the angled or biased cutting surface that directs liquids resulting from food being processed toward the hooded member instead of remaining in the work area. The angled surface of the board also makes it easier for the user to push cuttings off to one side, away from the work area of the cutting surface.

In the preferred embodiment, the feet or the bottom surface of the cutting board comprise a non-slip material, such as an elastomeric material, to prevent the cutting board from sliding on the countertop or table during use.

### BRIEF DESCRIPTION OF THE DRAWINGS

The attached drawings are intended to better illustrate a preferred embodiment of the present invention without limiting the invention in any manner whatsoever.

FIG. 1 is a perspective view of the cutting board of the present invention wherein the collapsible hood member is in its fully expanded configuration.

FIG. 2 is a side view of the cutting board of the present invention wherein the collapsible hood member is in its fully expanded configuration.

FIG. 3 is a top view of the cutting board of the present invention.

FIG. 4 is a bottom view of the cutting board of the present invention.

FIG. 5 is a perspective view of the cutting board of the present invention wherein the collapsible hood member is in its fully collapsed configuration.

FIG. 6 is a side view of the cutting board of the present invention wherein the collapsible hood member is in its fully collapsed configuration.

### DETAILED DESCRIPTION OF THE PREFERRED EMBODIMENT

The following description of the preferred embodiment is presented to describe the present invention and is not to be construed to limit the scope of the invention in any manner whatsoever.

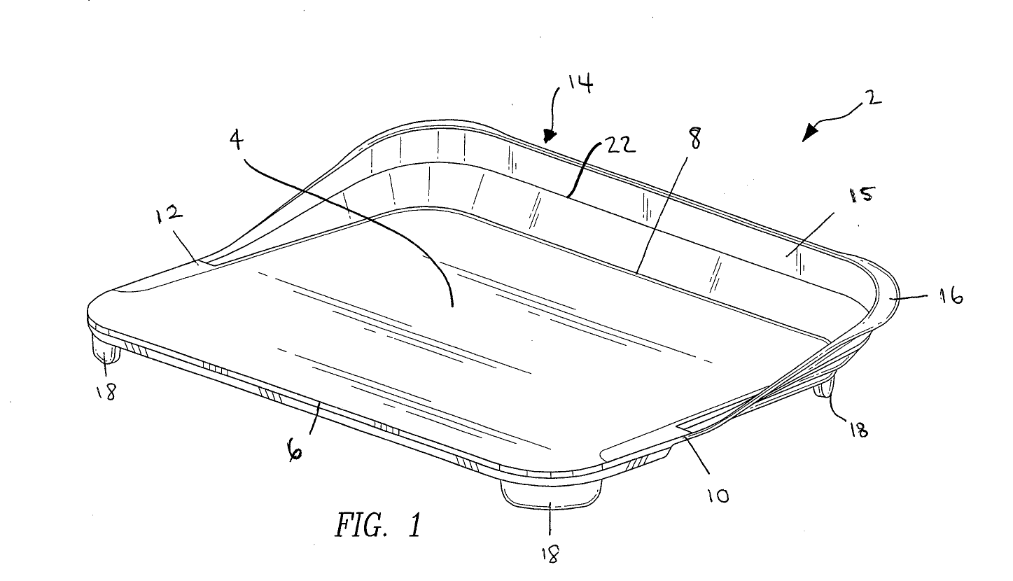

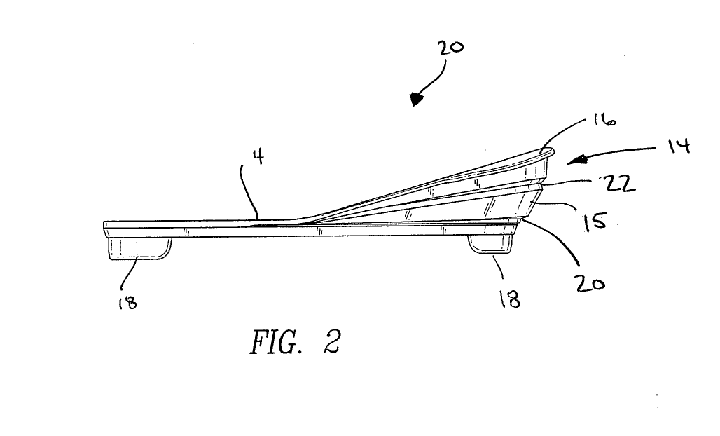

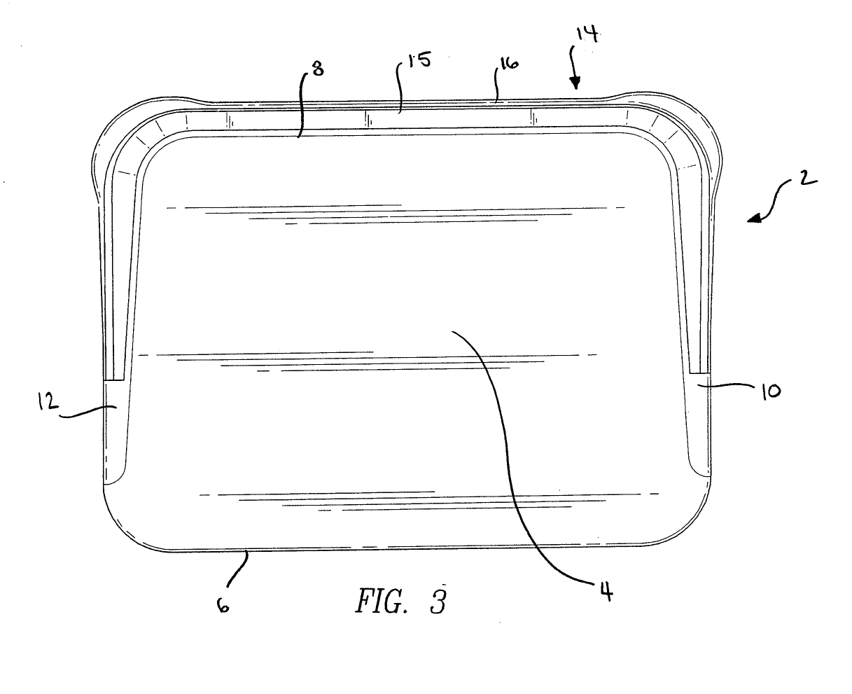

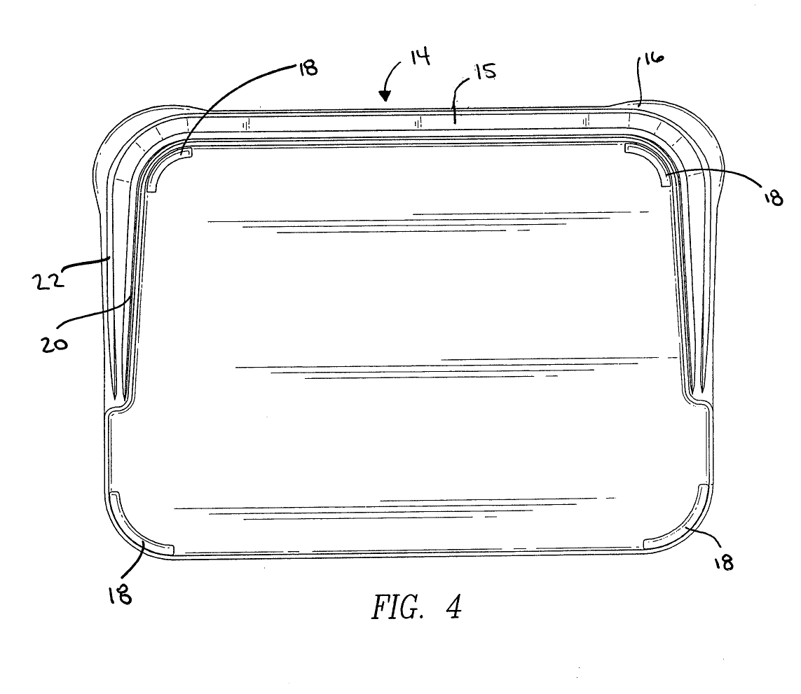

As best shown in the drawings, and particularly FIGS. 1-6, the preferred embodiment of the present invention is directed to a cutting board 2 comprising a biased cutting surface 4 with a front edge 6, a back edge 8, a first side edge 10 and a second side edge 12, and a collapsible hood member 14 that is convertible from a fully collapsed configuration to a fully expanded configuration, said collapsible hood member 14 comprising one or more folds in a flexible wall 15 having a terminal end 16.

The collapsible hood member 14 may have a substantially rigid rim at the terminal end 16 of the flexible wall 15. The rigid rim could be created by the terminal end 16 being formed of a substantially rigid plastic coupled to the flexible wall 14 or by a substantially rigid wire covered by the material of the flexible wall 14 at the terminal end 16. The hood member 14 having a substantially rigid rim at the terminal end 16 would not necessarily look any different, for illustration purposes, since the terminal end 16 of the flexible wall 15 could have the same shape and dimensions with or without a substantially rigid rim.

The collapsible hood member 14 can be positioned about any one or more of the edges of the cutting surface 4, but it is preferred that the hood member 14 extend about at least a portion of two edges of the cutting surface 4 in order to provide a more closed area to collect the cuttings and/or liquids, preventing them from falling or spilling off of the cutting board 2, as well as to provide a chute or spout for quick and clean displacement of the liquids and/or cuttings into containers with smaller openings or for disposal.

In the preferred embodiment shown, the hood member 14 extends across the back edge 8 and a majority of the side edges 10, 12, and is molded onto edges of the cutting surface 4 so that it collapses beyond the cutting surface 4 to maximize the work area of the cutting surface 4. The hood member 14 is preferably arcuate and expands upwardly and outwardly from the edges of the cutting board 2, providing the user with more room for holding cuttings that have been pushed away from the work area of the cutting surface 4.

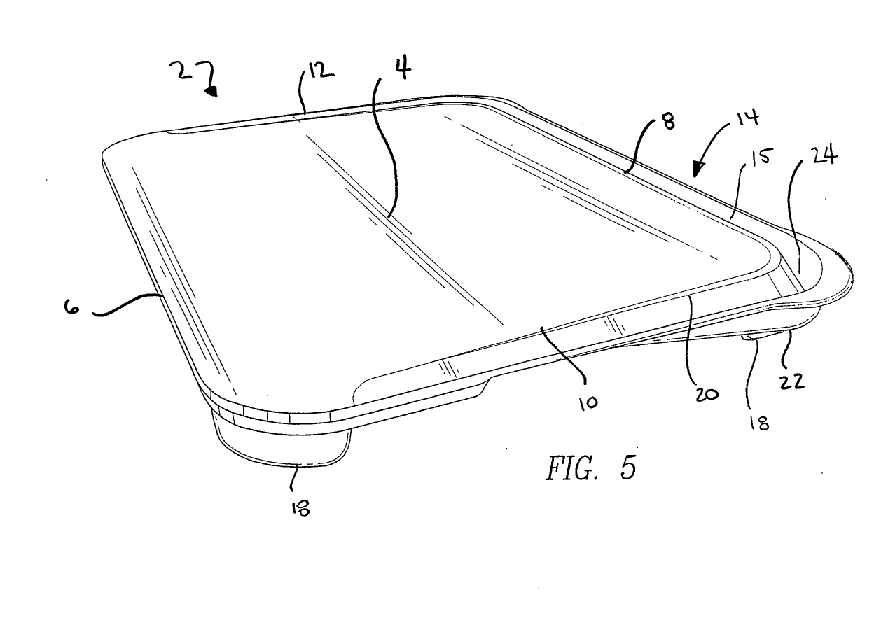

Although collapsing the hood member 14 can be facilitated by any number of folds or living hinges within the flexible wall 15, a first fold 20 adjacent the cutting surface 4 and a single intermediate fold 22 within the flexible wall 15 of the hood member 14 is most preferred. This permits the hood member 14 to collapse by folding at the first fold 20 adjacent the edge of the cutting surface 4 to create a downward hood wall to the intermediate fold line 22 and an upward hood wall from the intermediate fold line 22 to the terminal end 16 of the hood member 14. Such a configuration creates a groove 24 formed by the collapsed hood member 14, best shown in FIG. 5.

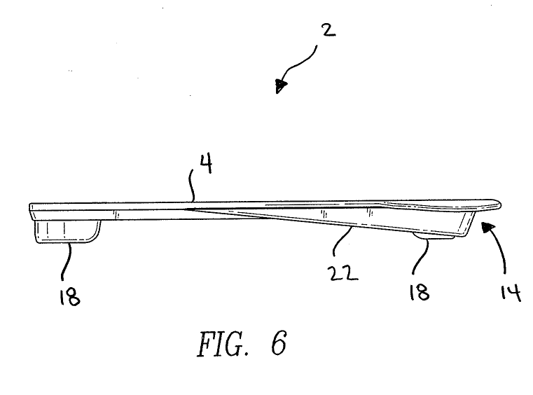

As shown in FIG. 6, the height of the hood member 14 in its collapsed configuration is preferably the same height as, if not slightly lower than, the back end 8 of the cutting surface 4. The groove 24 created by the collapsed hood member 14 is at the low end of the biased cutting surface 4 so that liquids from the food items being processed can flow away from the work area of the cutting surface 4 and directly into the groove 24 for temporary storage until the user is ready to dispose of it. The groove 24 further ensures that excess liquids can be transported to a container, sink or garbage without spilling, the corner of the hood member 14 providing a pour spout for draining the liquid from the groove 24.

When the hood member 14 is in its fully expanded configuration, as seen in FIGS. 1-3, the height of the side walls of the hood member 4 (along the side edges 10, 12), angle downward from a maximum height at the back edge 8 towards the front edge 6 of the cutting surface 4. In this embodiment, the side walls of the hood member 14 at the most forward points are no higher than the cutting surface 4 even when the hood member 14 is in its expanded configuration. In keeping, the fold lines 20, 22 in the flexible wall 15 diverge as they extend from the lowest point of the hood member 14 on the side edges 10, 12 of the cutting surface 4 toward the back wall of the hood member 14 at the back edge 8 of the cutting surface 4.

The expanded hood member 14 acts as a retention wall, catching excess fluids and/or cuttings and preventing them from spilling onto the countertop, table or other work surface. Moreover, the corner of the hood member 14, formed by the side and back walls of the expanded hood member 14, acts as a pouring spout for ease of transferring cuttings and/or liquids into another receptacle.

The flexible wall 15 of the hooded member 14 preferably comprises an elastomeric material, such as a thermoplastic elastomeric material, for ease of collapsing the hood member 14 along the fold lines 20, 22. When used, the substantially rigid rim is preferably formed of a substantially rigid plastic such as an acrylonitrile butadiene styrene or steel wire embedded in the elastomeric material of the flexible wall 15. Of course, other suitable materials may also be used to arrive at the present invention. For example, the hood member 14 may alternatively be formed from one or more silicone materials and the substantially rigid rim, if included, formed from one or more wood, metal, or other rigid or semi-rigid materials.

Each of the folds of the collapsible hood member 14 are most preferably formed as living hinges in which the elastomeric material forming the flexible wall 15 is somewhat thinner along the fold lines 20, 22 than the surrounding material, thereby making the material at the living hinge more susceptible to folding than the surrounding material. While the living hinge is formed by use of a thinner section of material in the preferred embodiment, it should be understood that the folding sections can be produced in other means in order to manufacture a location that is more likely to bend or fold than other areas.

In the preferred cutting board 2 shown, the front edge 6 of the cutting surface 4 is taller than the back edge 8, thereby creating the biased cutting surface 4 which directs fluids and cuttings toward the hood member 14. The cutting surface 4 is preferably made of a scratch-resistant polypropylene material, though any suitable materials may be used, such as wood, plastic, glass, or stone, high density polystyrene, and polyethylene.

In the most preferred embodiment, the height difference between the front edge 6 and the back edge 8 of the board 2 is created by the addition of feet 18 on the underside of an area corresponding to at least the front edge 6 of the cutting surface 4, although a cutting board with a thicker front edge 6 than back edge 8 could be used. Preferably, the cutting board 2 has feet 18 at four corners, most preferably with the feet 18 having portions on both edges associated with each corner of a rectangular cutting surface 4 for maximum stability during use of the cutting board 2, with the feet 18 at the front edge 6 being taller than the feet 18 at the back edge 8.

The feet 18 preferably comprise an elastomeric material, such as an elastomeric coating, to provide a non-slip characteristic when placed on a countertop, table or other work surface. Although any non-slip material can be used, use of the thermoplastic elastomeric material that is used for the flexible middle section of the hood member 14 is preferred. In keeping, the feet 18 not only create the angle of the cutting surface 4, but also the non-slip characteristic for improved use of the cutting board 2 and the elevation of the cutting board 2 from the countertop, table or other work surface for added user comfort. The use of four feet 18 at the corners of the cutting board 2 also minimizes the surface area of contact between the cutting board 2 and the countertop, table or other work surface so that cleaning is easier.

Variations, modifications and alterations to the above detailed description will be apparent to those skilled in the art. All such variations, modifications and/or alternatives are intended to fall within the scope of the present invention, limited only by any allowed claims. All cited patents and publications are hereby incorporated by reference.

We claim:

1. A cutting board comprising a cutting surface, said cutting surface having a front edge, a back edge, a first side edge and a second side edge, and a collapsible hood member convertible from a collapsed configuration to an expanded configuration, said hood member extending along at least a portion of at least one edge of the front edge, back edge, first side edge and second side edge of the cutting surface.

2. The cutting board of claim 1 wherein the hood member extends continuously along at least a portion of two adjacent edges.

3. The cutting board of claim 1 wherein the hood member extends continuously across the entire back edge and along at least a portion of each of said first side edge and said second side edge.

4. The cutting board of claim 3 wherein the hood member extends along a majority of each of said first side edge and said second side edge.

5. The cutting board of claim 1 wherein the hood member has a maximum height and the height of the hood member increases along at least a portion thereof from a height substantially even with the cutting surface to the maximum height.

6. The cutting board of claim 1 wherein the hood member comprises one or more folds upon which the hood member collapses.

7. The cutting board of claim 1 further comprising a groove formed by the hood member in its collapsed configuration.

8. The cutting board of claim 1 further comprising a retention wall formed by the hood member in its expanded configuration.

9. The cutting board of claim 1 further comprising a pour spout formed by the hood member in its expanded configuration.

10. The cutting board of claim 1 wherein the hood member comprises a flexible wall coupled to the cutting surface.

11. The cutting board of claim 10 wherein the hood member further comprises a substantially rigid rim at a terminal end.

12. The cutting board of claim 10 wherein the hood member has a terminal end that extends outwardly.

13. The cutting board of claim 1 further comprising one or more feet extending downwardly from the cutting board.

14. The cutting board of claim 1 further comprising one or more feet extending downwardly from an area substantially below the front edge of the cutting surface.

15. The cutting board of claim 14 further comprising one or more feet extending downwardly from an area substantially below the back edge of the cutting surface.

16. The cutting board of claim 15 wherein the one or more feet extending downwardly from the area substantially below the front edge of the cutting surface are taller than the one or more feet extending downwardly from the area substantially below the back edge of the cutting surface.

17. The cutting board of claim 13 wherein at least one of the one or more feet comprise an elastomeric material.

18. The cutting board of claim 1 wherein the cutting board is thicker at the front edge than at the back edge.
